(19) United States
(12) Patent Application Publication
(10) Pub. No.: US 2012/0240324 A1
(43) Pub. Date: Sep. 27, 2012

(54) SYSTEM AND METHODS FOR COVERING A POOL WITH AN INSULATED ROLLUP COVER

(75) Inventor: Patrick Callahan, Escondido, CA (US)

(73) Assignee: POOLSAFE, INC., Escondido, CA (US)

(21) Appl. No.: 13/426,497

(22) Filed: Mar. 21, 2012

Related U.S. Application Data
(60) Provisional application No. 61/467,328, filed on Mar. 24, 2011.

(51) Int. Cl. E04H 4/00; B32B 37/06; B32B 37/14; B32B 37/12

(52) U.S. Cl. 4/502; 156/334; 156/306.6

(57) ABSTRACT

Systems and methods for covering a manmade pool (10) are disclosed. The system comprises an insulating cover (12) and a roller (14) positioned along at least one edge of the pool (10), wherein the roller is attached to at least one edge of the insulating cover (12) and the insulating cover is capable of being wound upon the roller (14). In an embodiment, the system further comprises a guide (18) capable of guiding at least one leading edge of the insulating cover (20) across the pool (10), such that the insulating cover can be moved from an open position, with the insulating cover wound around the roller (14), to a closed position, with the insulating cover secured over the pool. In some embodiments, the insulating cover (12) further comprises reinforcing material that adds sufficient strength to the cover that when in the closed position over the pool, the cover can support the weight of at least one adult human.

### BACKGROUND OF THE INVENTION

1. Field of the Invention

The present invention relates to systems, devices, and methods of covering a pool with an insulating cover and methods of manufacturing said insulating covers.

2. Description of the Related Art

Manmade pools are containers filled with water and are sometimes used for swimming or water-based recreation. Pools come in many sizes including single person spas or hot tubs, two to eight person spas or hot tubs, swim-spas, backyard private pools, large private pools, and Olympic swimming pools. Swim spas are typically larger than regular spas, but may be heated above normal swimming pool temperatures. They are often longer than they are wide, and may be, for example, approximately 8 feet by 16 feet. Outdoor pools can sometimes be heated by solar energy. To facilitate heating indoor pools and outdoor pools to higher temperatures, pools may include heaters. A heater may heat a pool to high temperatures, sometimes exceeding 100° F. Spas, hot tubs, or swim-spas are smaller than many other types of pools and are sometimes heated to higher temperatures.

Because pools contain a large amount of water, the cost of heating pools can be substantial. To keep pools clean and reduce heating costs, sometimes pools are covered by a pool cover. Pool covers reduce evaporation and heat loss due to evaporation. Some pool covers are even strong enough to support a human being and may be used for safety purposes.

Often times, heated pool or spa may use an insulating cover to further reduce heat loss. These covers are traditionally made of a rigid foam core about three to six inches thick that can be covered in a vinyl cover. Because such covers have a tendency to accumulate water in the foam, the vinyl cover is often removable to facilitate drying out the foam core. Traditional covers for very small spas may be made of a single piece of rigid foam. For larger spas and swim spas, it may be impractical to remove a single piece of rigid foam at once. For these types of pools, traditional covers are often divided into two or more portions which may be folded on top of one another or removed individually. However, because said traditional covers tend to accumulate water in the foam core, they can become extremely heavy to lift, and the water in the foam may compromise its insulative properties.

Because of the difficulty in lifting such heavy covers, support devices may be employed to facilitate lifting said covers. Those support devices sometimes included hinged frames that allowed heavy, multi-piece covers to be draped over the frame and removed from the surface of the pool. However, because swim-spas are larger than traditional spas, it may be impractical to use such support devices. Furthermore, moving such devices can be impractical for some people that may be unable to lift heavy objects. It is desirable to provide systems and methods concerning lightweight insulating pool covers that are easily removed. In addition, due to the risk of drowning or unauthorized use, security pool covers are enjoying wide popularity. Such covers can often support the weight of a person, are typically made of reinforced vinyl fabric, can be rolled up, and may be secured on all sides. However, they provide little insulative value.

### SUMMARY OF THE INVENTION

Disclosed herein is a system for covering a manmade pool. In one embodiment, the system comprises an insulating cover with at least one insulation layer and at least one flexible outer layer that substantially covers the at least one insulation layer. The system may also comprise a web of fibrous reinforcing material in the insulating cover. In an embodiment, a roller can be positioned along at least one edge of the pool and attached to at least one edge of the insulating cover. In an embodiment, the insulating cover can be capable of being wound upon the roller. The system may also comprise an actuator for rotating the roller. In an embodiment, the system comprises a guide capable of guiding at least one leading edge of the insulating cover across the pool, such that the insulating cover can be moved from an open position, with the insulating cover wound around the roll, to a closed position, with the insulating cover secured over the pool. In some embodiments, the reinforcing material adds sufficient strength to the cover that, when in the closed position over the pool, the cover can support the weight of at least one adult human.

Also disclosed is an insulating cover. In one embodiment, the insulating cover comprises an insulation layer of closed cell foam having a thickness between about 0.1 and about 1 inch. The insulating cover may also comprise at least one flexible outer layer that substantially covers the insulation layer. In an embodiment, the insulating cover can be capable of being wound upon a roller.

Also disclosed is a method of manufacturing an insulating cover. In one embodiment, the method comprises pouring or laminating vinyl onto or around a mesh reinforcement material to form at least one flexible outer layer. In one embodiment, the method comprises substantially covering at least one insulation layer with at least one flexible outer layer. The method may also comprise bonding the insulation layer to the flexible outer layer.

Also disclosed is an insulated material. In one embodiment, the insulated material comprises a first web of a flexible polymer material and an insulating layer of closed cell foam having a thickness between about 0.1 and about 1 inch. The insulated material may also comprise a reinforcing mesh therein. In a particular embodiment, the insulated material comprises a second web of flexible polymer material, wherein the mesh layer can be embedded in the flexible polymer material or the foam and the foam can be enclosed (e.g., top and bottom) by the first and second webs of polymer. The insulated material may include a sheet of material having edges and capable of being wound around a roller and the insulated material can have sufficient strength that when supported by its edges and covering a spa, swim spa, or pool, it can support an adult human (e.g., 70 kgs).

### BRIEF DESCRIPTION OF THE DRAWINGS

FIG. 1 depicts a perspective view of an embodiment of a system for covering a manmade pool.

FIG. 2A depicts a cross-sectional view of a guide.

FIG. 2B depicts a cross-sectional view of a guide.

FIG. 3 depicts a cross-sectional view of an insulating cover.

FIG. 4 depicts a perspective view of an embodiment of a system for covering a manmade pool.

FIG. 5 depicts several views of mounting brackets.

### DETAILED DESCRIPTION OF THE PREFERRED EMBODIMENT

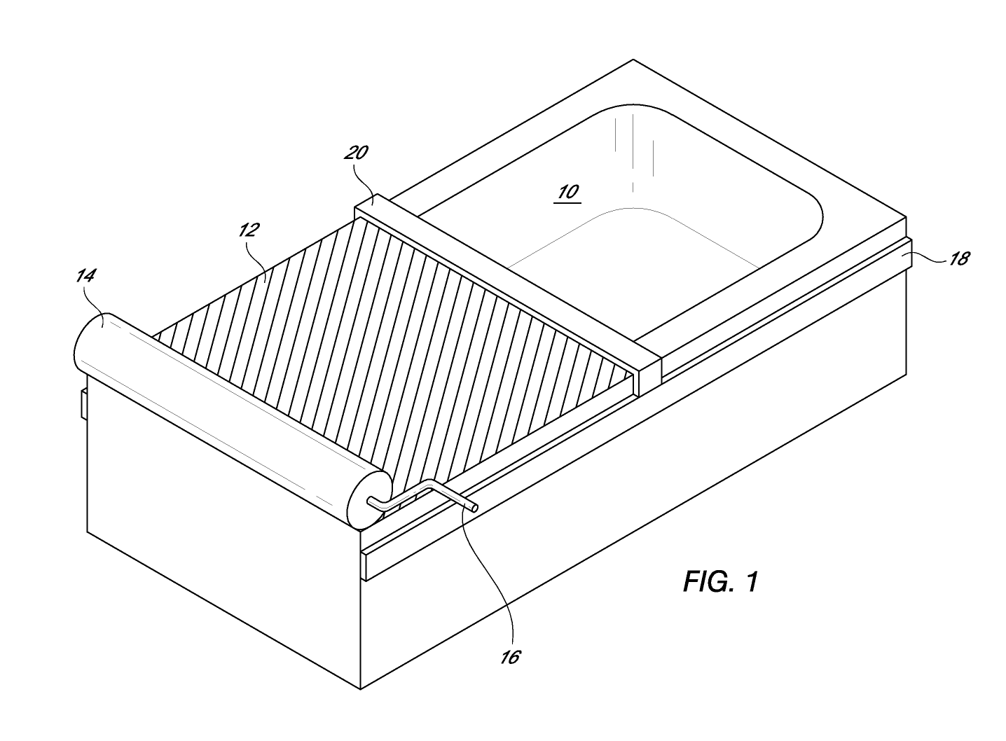

FIG. 1 depicts an embodiment of a system for covering a manmade pool 10. As used herein, the terms “manmade pool” or “pool” may including a pool, spa, swim-spa, hot tub, tub, Jacuzzi, pond or any other manmade body of water. In some embodiments, the manmade pool 10 can be a pool, spa, or swim-spa. In an embodiment, the manmade pool 10 can be a spa or swim-spa. In some embodiments, the system comprises an insulating cover 12. In some embodiments, the insulating cover 12 can be large enough to cover a spa or swim spa that can be about 6 feet wide by about 6 feet long, about 6 feet wide by about 12 feet long, about 8 feet wide by about 12 feet long, or about 8 feet wide by about 16 or 20 feet long. In a non-limiting embodiment, the length of the insulating cover 12 may be about 4, 5, 6, 7, 8, 9, 10, 11, 12, 13, 14, 15, 16, 17, 18 or 20 feet or a range of any of the proceeding values. Alternatively, the insulating cover can be fabricated in significantly longer lengths to cover pools up to 50, 100, 150, 200 or more feet, or can be rolled onto rolls of any desired length after manufacturing and then cut and finished to a desired length prior to installation. In a non-limiting example, the width of the insulating cover 12 may be about 4, 5, 6, 7, 8, 9, 10, 11, 12, 13, 14, 15, or 16, 17, or 18 feet or more, or a range of any of the proceeding values. In an embodiment suitable for spas, swim spas, and other similarly-sized pools, the insulating cover 12 can be from between about 5 feet long and about 20 feet long and from between about 5 feet wide to about 12 feet wide.

In some embodiments of a pool cover installation or system, the insulating cover 12 may be wound upon a roller 14. The roller 14 can be generally cylindrically shaped and rotatable to wind the insulating cover 12 upon the roller 14 or unwind the insulating cover 12 from the roller 14. In some embodiments, the roller 14 may be rotated by using an actuator 16. The actuator 16 may be manual, semi-automatic, or automatic. A manual actuator 16 may include any device operated by human or animal power. Examples of such actuators include hand cranks, foot cranks or other similar devices. When using a semi-automatic actuator 16, the actuator 16 comprises an interface attached to the roller and a separate power supply. The separate power supply may be a removable motor, such as a cordless drill, or a dedicated motor attached directly to the roller 14 or indirectly through a drive train (for example, through gears, belts, chains, pulleys, and the like). The interface may extend into the roller 14 or out from the roller 14 and permits the separate power supply to attach to the roller 14 and provide power to rotate the roller 14. An automatic actuator 16 may comprise an electric, gas, hydraulic, or other type of motor that can be attached to the roller 14.

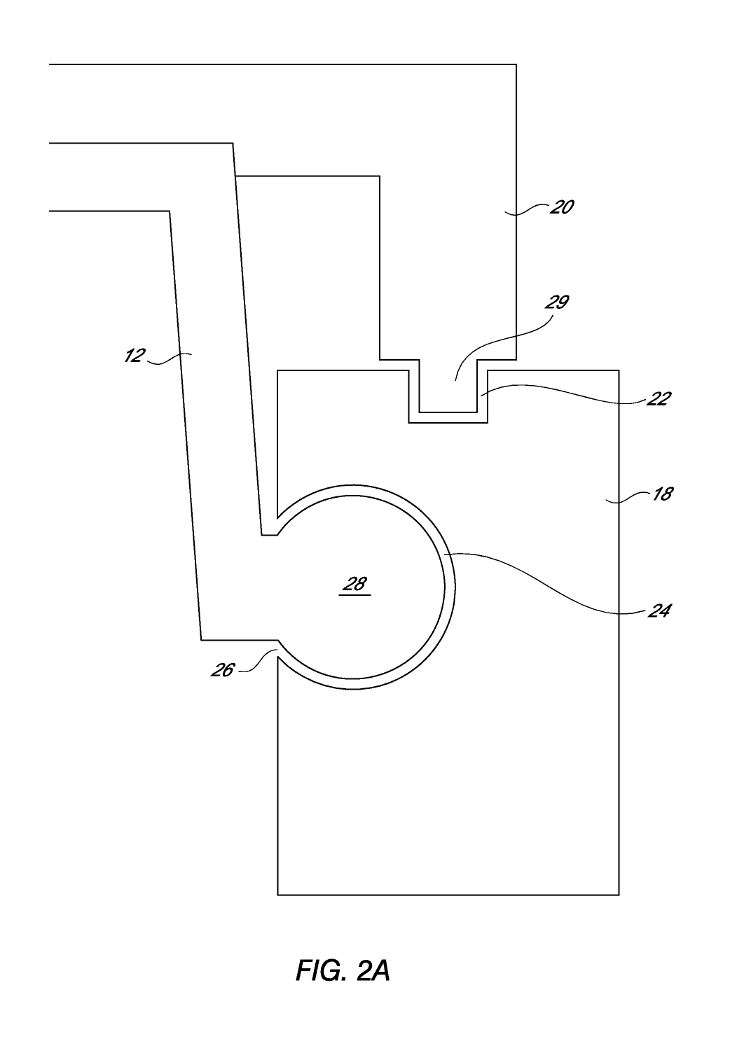

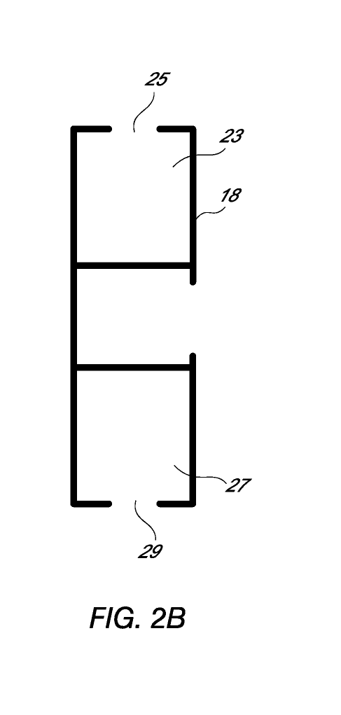

In some embodiments, the system contains at least one guide 18 capable of guiding at least one leading edge 20 of the insulating cover 12 across the pool 10. The guide 18 allows the insulating cover 12 to be moved from an open position, with the insulating cover wound around the roll, to a closed position, with the insulating cover secured over the pool. The guide 18 is shown in more detail in FIG. 2. When implemented in connection with a security cover that can hold the weight of a child, an adult, or both, the guide can secure an edge of the cover 12 and maintain it in place despite significant weight on the cover. At the same time, the guide 18 preferably allows the cover 12 to slide through the guide 18 along the length of the pool 10.

FIG. 2A depicts a cross-section of the guide. The guide 18 may be made of a strong rigid material such as aluminum, steel, iron, or other metal. In some embodiments, the guide 18 can be made of aluminum. In an embodiment, the guide 18 can be made from extruded aluminum. In some embodiments, the guide may contain a track 22 sized such that a portion of the leading edge 20 of the insulating cover 12 may fit inside the track 22. In an embodiment, the guide 18 also comprises a hollow section 24 with an opening 26 that can be smaller than the size of the hollow section 24, such that at least one bead 28 attached to (or otherwise formed at the edge of) the insulating cover 12 can be placed inside the hollow section and cannot be pulled from the guide 18 through the opening 26. In some embodiments, the insulating cover 12 also comprises a slider 29 which can be attached to the leading edge 20. The slider 29 may be made out of any rigid material, such as plastic or metal. In some embodiments, the slider 29 can be plastic. The slider fits inside the hollow section 24 of the guide similarly to the bead 28. The slider 29 may also have an elongated fibrous material, such as a rope, attached to it. In some embodiments, the rope may be pulled to pull the leading edge 20 of the insulating cover 12 across the pool 10 and unwind the roller 14. In other embodiments, the rope may extend from the leading edge 20 of the insulating cover 12 to the edge of the pool opposite the roller 14, passed through a pulley or other similar device, and returned to the roller 14. In others, the rope comprises a pair of ropes or other tensile members extending along either side of the pool. Such a configuration permits the insulating cover 12 to be moved to a closed position by rotating the roller 14 in the opposite direction used to move the insulating cover 12 to an open position. FIG. 2B depicts a cross-section of another embodiment of the guide. In that embodiment, the slider 29 and at least one bead 28 can be both passed through a hollow section 23. The hollow section 23 can have an opening 25 that can be smaller than the size of the hollow section 23, such that the at least one bead 28 attached to (or otherwise formed at the edge of) the insulating cover 12 can be placed inside the hollow section and cannot be pulled from the guide 18 through the opening 25. In some embodiments, the guide may also contain a hollow section 27, with an opening 29 that can be smaller than the size of the hollow section 27, such that the rope can be placed inside the hollow section 27 and cannot be pulled from the guide 18 through the opening 29.

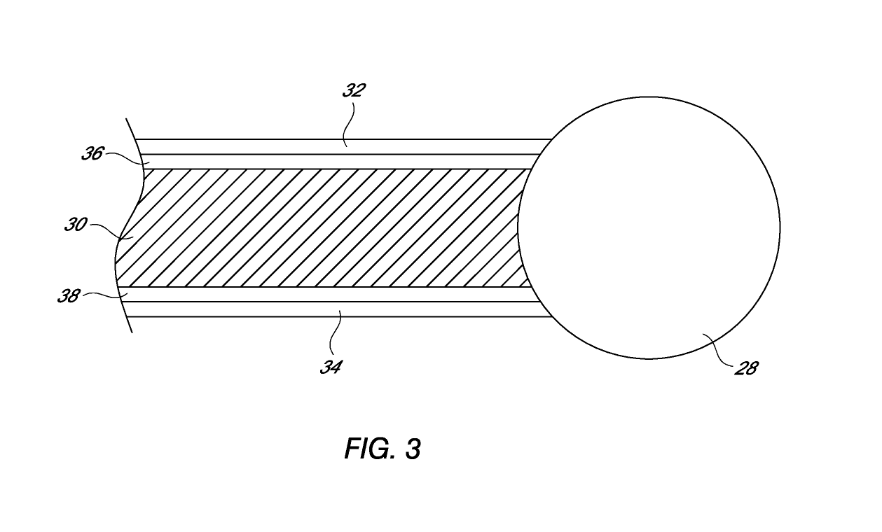

The bead 28 can be formed, for example, by embedding cording or rope in the edge of the cover 12, such as by wrapping an edge of the cover 12 around cord or other beading and then sewing, gluing, heat welding, or otherwise securing the wrapped portion around the beading. Alternatively, a bead 28 can be integrally formed with the cover during manufacture from the same or different polymer as the cover or from some other material; molded into or onto the cover material, ultrasonically welded or otherwise bonded onto the cover, or attached or formed in any other known manner. In some embodiments, the term “bead” is used in a broad sense to encompass both continuous and noncontinuous edge elements that interact with a track or other cooperating structure at or near the edge of a pool 10 to slidably secure the edge of the cover 12. In an embodiment, the insulating cover 12, the guide 18, and the bead 28 can be strong enough that, when in the closed position over the pool, the insulating cover 12 can support the weight of at least one adult human without tearing the cover 12 or pulling the bead 28 from the hollow section 24 of the guide 20 through the opening 26. The structure of a preferred insulating cover 12 is shown in more detail in FIG. 3.

FIG. 3 depicts a cross-section of an insulating cover 12. In some embodiments, the insulating cover comprises at least one bead 28 along at least one edge of the insulating cover 12. (Note that the bead 28 is shown schematically, as the structure may include the cover 12 material wrapped and secured around beading or any of the other structures contemplated herein, and the cross section can not only be round, but square, rectangular, angled, a combination of straight lines and curves, and so forth.) The bead may advantageously be configured to fit inside the hollow section 24 of the guide 20. In an embodiment, the insulating cover 12 comprises at least one bead 28 on each of two edges of the insulating cover 12 perpendicular to the roller 14 and parallel to two guides 20 positioned along the edge of the pool 10. In an embodiment, the at least one bead 28 comprises a continuous bead or rope that can be attached to at least one edge of the insulating cover 12. In a preferred embodiment the insulating cover 12 comprises two continuous beads 28 made from rope, each of which can be attached to an opposite edge of the insulating cover 12 such that they can be perpendicular to the roller 14 and parallel to the guides 18. In a preferred embodiment of a pool cover system, the insulating cover has a first edge fastened to the roller 14, second and third edges parallel to each other and orthogonal to the first edge that can be slidably fastened to the guides 20 by means of beads 28, and a fourth edge opposite of and parallel to the first edge, that can move from a first deployed position at a side of the pool opposite to the roller 14 to a second, open position at or near the roller 14. When the fourth (leading) edge is in its deployed position, it can preferably be secured such that it can be maintained in position and resists movement toward the inside of the pool when weight is applied down onto the deployed cover.

In some embodiments, the insulating cover 12 comprises at least one insulating material layer 30 and a first flexible outer layer 32. The insulating cover 12 may comprise a number of insulating material 30 layers that may each, independently, be made of closed cell foam, open cell foam, or other similar material. It can be made of any suitable material, including foamed polymers, such as polyethylene, polypropylene, polybutadiene, neoprene, nitrile rubber, polyurethane, polyamide, polyimide, silicone, butyl rubber, natural or synthetic rubber (including vulcanized rubber), EPDM, Polyvinyl Chloride Nitrile Butadiene Rubber, minicell foam, blends and copolymers, including polyvinyl chloride blended with any of the foregoing, and any other foamable material, preferably a foamed elastomer. In an embodiment, the insulating material 30 can be made from a foam that can have a weight of about 0.5 lbs/ft³, 1 lbs/ft³, 1.5 lbs/ft³, 2 lbs/ft³, 2.5 lbs/ft³, or 3 lbs/ft³, or a range of any of the proceeding values. In some embodiment, the insulating material 30 can be made from a foam that can have a weight of about 1.5 lbs/ft³ to about 2.5 lbs/ft³. In an embodiment, the insulating material 30 can be made from a foam that can have a weight of about 2 lbs/ft³. In an embodiment, the insulating material 30 is closed cell foam with a weight of about 2 lbs/ft³. In an embodiment, the insulating material 30 comprises more than one type of foam. In some embodiments the insulating material 30 comprises at least one type of open cell foam and at least one type of closed cell foam. In an embodiment, the insulation layer 30 has a thickness of about 0.1, 0.2, 0.25, 0.3, 0.4, 0.5, 0.6, 0.7, 0.75, 0.8, 0.9, 1.0, 1.1, 1.2, 1.25, 1.3, 1.4, 1.5 inches, or a range of any of the proceeding values. In some embodiments, the thickness of the layer of insulating material 30 can be between 0.1 and 1 inch. In an embodiment, the thickness of the layer of insulating material 30 can be between about 0.25 and about 0.5 inches thick.

In an embodiment, the insulating cover 12 comprises a first flexible outer layer 32 and a second flexible outer layer 34. The first flexible outer layer 32 and second flexible outer layer 34 may each, independently, be made of flexible polymer material such as polyvinyl chloride (vinyl), polyethylene, polyurethane, polyvinylidene chloride, or any other similar material. In an embodiment, the first flexible outer layer 32 and second flexible outer layer 34 may each, independently, comprise poured vinyl or laminated vinyl. In some embodiments, the first flexible outer layer 32 and the second flexible outer layer 34 may each comprise laminated vinyl. In an embodiment, the first flexible outer layer 32 and second flexible outer layer 34 substantially cover or sandwich the layer of insulating material 30.

The insulating cover may also comprise a web of fibrous reinforcing material 36. The web of fibrous reinforcing material 36 may be positioned between any flexible outer layer 32,34 and at least one layer of insulating material 30, disposed within any flexible outer layer 32,34, or disposed within any layer of insulating material 30. The web of fibrous reinforcing material 36 may be made of polyester, polyamide, or any other material that will increase the strength of the insulated cover. In some embodiments, the web of fibrous reinforcing material 36 can be a mesh material.

In an embodiment, the insulating cover 12 also comprises at least one layer of metalized material 38. The layer of metalized material may be made of aluminum, gold, silver, copper, titanium, steel, or other metal. In some embodiments, the layer of metalized material may be sputtered, vapor deposited, electrodeposited, or deposited on or bonded to the polymer layer. The insulating cover 12 may also contain additional layers, such as a layer of mylar, and the mylar may optionally be metalized. In some embodiments the metalized material can be applied using infrared heaters. While the insulating materials can reduce heat transfer by conduction, a metalized layer may reduce heat loss through radiation.

In an embodiment, the insulating cover 12 also comprises at least one scrim that can be used to provide additional strength and/or stability. The scrim can comprise multiple layers. In some embodiments, the scrim can comprise fibrous tissues reinforced with a layer of another material such as nylon. In some embodiments, the scrim can comprise light textiles such as cotton or flax. In an embodiment, an insulating layer 30 can be positioned between the first flexible outer layer 32 and the second flexible outer layer 34. In some embodiments, the insulating layer 30, first flexible outer layer 32, and second flexible outer layer 34 can be bound together. Optionally, the at least one insulating layer 30, first flexible outer layer 32, and second flexible outer layer 34 can be bonded together using a suitable adhesive. Suitable adhesives may contain several components. For example, the adhesive may contain polymers and copolymers such as vinyl polymers, acrylic polymers, and other suitable polymers. Such polymers may include one or more monomer components such as (meth)acrylic acid, methyl(meth)acrylate, ethyl(meth)acrylate, n-propyl(meth)acrylate, isopropyl(meth)acrylate, n-butyl(meth)acrylate, isobutyl(meth)acrylate, tert-butyl(meth)acrylate, n-pentyl(meth)acrylate, n-hexyl (meth)acrylate, cyclohexyl(meth)acrylate, n-heptyl(meth)acrylate, n-octyl(meth)acrylate, 2-ethylhexyl(meth)acrylate, nonyl(meth)acrylate, decyl(meth)acrylate, dodecyl(meth)acrylate, phenyl(meth)acrylate, toluoyl(meth)acrylate, benzyl(meth)acrylate, 2-methoxyethyl (meth)acrylate, 3-methoxybutyl(meth)acrylate, 2-hydroxyethyl(meth)acrylate, 2-hydroxypropyl (meth)acrylate, stearyl(meth)acrylate, glycidyl(meth)acrylate, 2-aminoethyl(meth)acrylate, ′-(methacryloyloxy)propyltrimethoxysilane, (meth)acrylic acid-ethylene oxide adducts, trifluoromethylmethyl(meth)acrylate, 2-trifluoromethylethyl(meth)acrylate, 2-perfluoroethylethyl(meth)acrylate, 2-perfluoroethyl-2-perfluorobutylethyl(meth)acrylate, 2-perfluoroethyl(meth)acrylate, perfluoromethyl(meth)acrylate, diperfluoromethylmethyl (meth)acrylate, 2-perfluoromethyl-2-perfluoroethylmethyl(meth)acrylate, 2-perfluorohexylethyl (meth)acrylate, 2-perfluorodecylethyl(meth)acrylate, 2-perfluorohexadecylethyl(meth)acrylate and like (meth)acrylic monomers; styrene, vinyltoluene, á-methylstyrene, chlorostyrene, styrenesulfonic acid and salts thereof, and like styrenic monomers; perfluoroethylene, perfluoropropylene, vinylidene fluoride and like fluorine-containing vinyl monomers; vinyltrimethoxysilane, vinyltriethoxysilane and like silicon-containing vinyl monomers; maleic anhydride, maleic acid, maleic acid monoalkyl esters and dialkyl esters; fumaric acid, fumaric acid monoalkyl esters and dialkyl esters; maleimide, methylmaleimide, ethylmaleimide, propylmaleimide, butylmaleimide, hexylmaleimide, octylmaleimide, dodecylmaleimide, stearylmaleimide, phenylmaleimide, cyclohexylmaleimide and like maleimide monomers; acrylonitrile, methacrylonitrile and like nitrile group-containing vinyl monomers; acrylamide, methacrylamide and like amide group-containing vinyl monomers; vinyl acetate, vinyl propionate, vinyl pivalate, vinyl benzoate, vinyl cinnamate and like vinyl esters; ethylene, propylene and like alkenes; butadiene, isoprene and like conjugated dienes; vinyl chloride, vinylidene chloride, allyl chloride and allyl alcohol, among others. Such polymers may also be optionally cured or crosslinked using a crosslinking agent such as a polyisocyanate compound, epoxy compound, polycarboxylic acid, polyamine compound, phenolic resin or sulfur compound, and other techniques including siloxane bonding. In some embodiments, the adhesive may contain additional compounds, such as hydrosilyl group-containing compounds, resins, surfactants, emulsifying agents, and tackifiers. In some embodiments, at least one insulating layer 30, a first flexible outer layer 32, and a second flexible outer layer 34 can be integrally formed together. The term “integrally formed” includes forming by coextrusion, pouring, laminating, spraying, or any processes that involves binding the layers together while a relevant portion of one or more layers can be in a softened or liquid state.

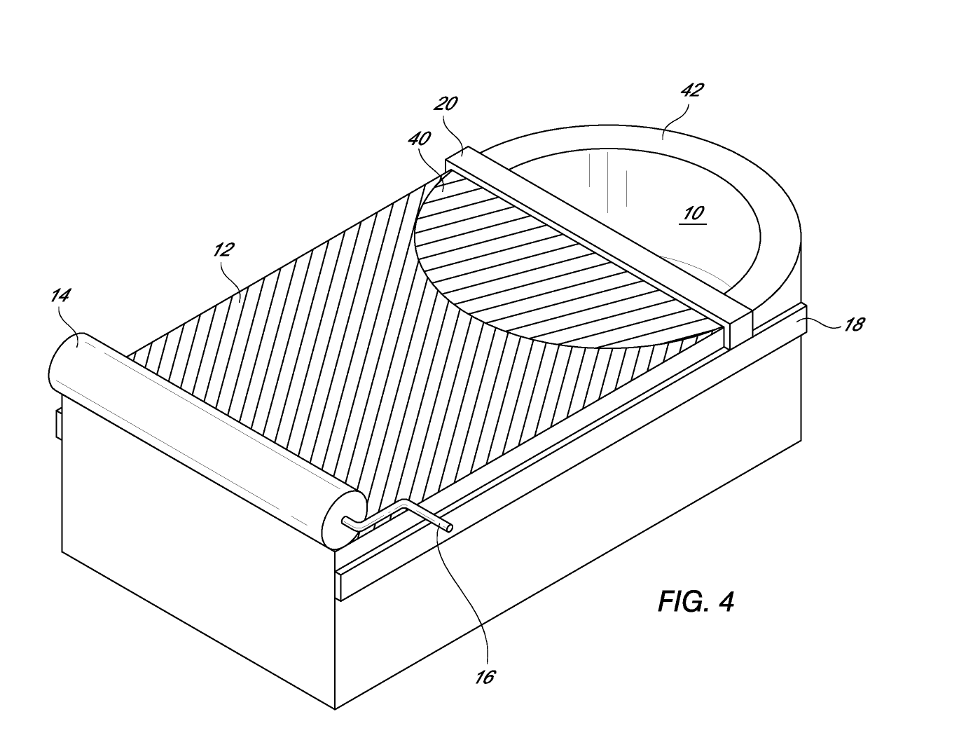

In some embodiments, the insulating material can be heat bondable. In an embodiment, the insulating material can be flame bondable. In some embodiments, at least one insulating layer 30 and a first flexible outer layer 32 can be bound together using a flame bondable insulating material. In some embodiments, at least one insulating layer 30, a first flexible outer layer 32, and a second flexible outer layer 34 can be bound together using a flame bondable insulating material. In an embodiment, the flame bondable insulating material comprises at least one of a closed cell foam and an open cell foam. In an embodiment, the flame bondable insulating material comprises both a closed cell foam and an open cell foam. In some embodiments, the metalized material may be applied to the insulating material before or after flame bonding. In an embodiment, the metalized material is applied to the insulating material before flame bonding. In an embodiment, the metalized material can be applied to foam using an infrared heater. Some pools have irregularly shaped portions. The irregularly shaped portion may comprise any shape that is not rectangular, such as a curved edge of a pool. To cover these portions of the pool the insulating cover may comprise one or more flaps 40 attached to at least one edge of the insulating cover 12. The flap may be made of any suitable material, including any material or combination of materials that may be used to make the insulating cover 12. In one embodiment, the flap can fold out to cover an irregularly shaped portion of a pool. In some embodiments, the insulating cover comprises a flap that can be attached to the leading edge 20 of the insulating cover 12 and can be used when the insulating cover 12 is in a closed or deployed position. FIG. 4 shows the insulating cover in the closed position with the flap 40 folded over the insulating cover 12. In FIG. 4, the flap 40 is curved and can be folded out to cover a curved portion 42 of a pool 10. The flap may also be used to cover other portions of a pool, such as an acrylic top of the pool. In one embodiment, the flap can be the shape of a rectangle and can be folded down to cover an exposed portion of the side of the pool, such as an acrylic top. Some pools 10 have two or more curved portions 42. In an embodiment, the pool 10 may comprise a first curved portion at one edge, and a second curved portion at the opposite edge of the pool. Flaps 42 may be used to cover more than one of the curved portions 42.

In some embodiments, it may be desirable to position the roller 14 on one edge of the pool 10 that can be a curved portion 42. The roller 14 may be mounted at the edge of the curved portion by using support beams to support the roller 14. The support beams may mount to the ground, another structure, or the side of the pool 10 itself.

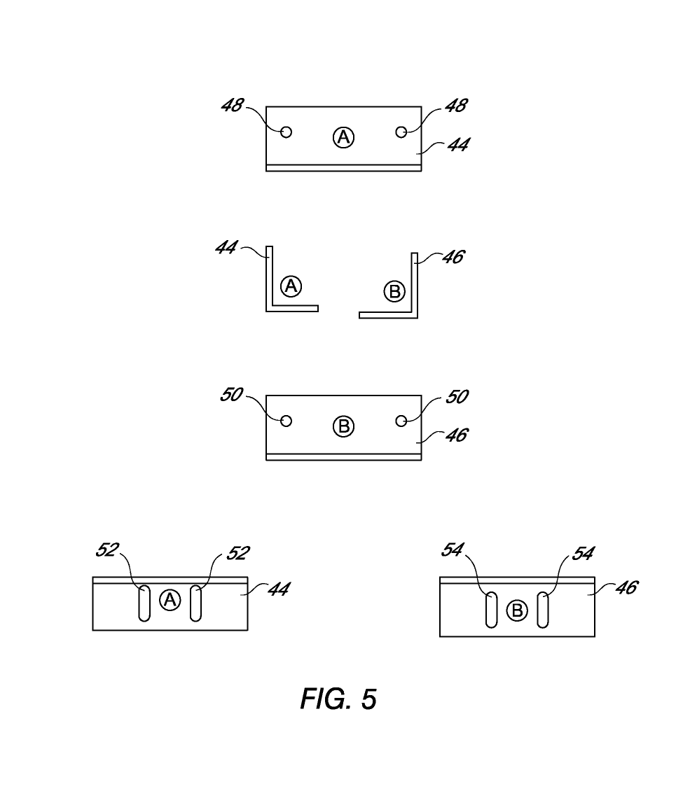

In some embodiments, the roller 14 may be mounted on a pool 10, such as an above-ground pool. The roller may be mounted using any suitable mounting bracket. For example, FIG. 5 shows several views of a suitable mounting bracket.

Also disclosed herein is a method of manufacturing an insulating cover 12. In some embodiments, the method comprises pouring or laminating a polymer onto at least one web of fibrous reinforcement material 36 to form at least one flexible outer layer 32, 34. In some embodiments, the first flexible outer layer 32 and the second flexible outer layer 34 may be made by laminating a polymer onto at least one web of fibrous reinforcement material 36. In a preferred embodiment, the fibrous reinforcement material can be a polyester mesh. The method may also comprise substantially covering at least one layer of insulating material 30 with at least one flexible outer layer 32, 34. In some embodiments, the method comprises covering at least one layer of insulating material 30 with a first flexible outer layer 32 on a first side of the insulating material 30 and a second flexible outer layer 34 on a second side of the insulating material 30.

In some embodiments, the method further comprises bonding the an insulation layer 30 to one or more flexible outer layers 32, 34. Said bonding may be accomplished by bonding any number of the layers together. For example, the first flexible outer layer 32 could be bonded to at least one layer of insulating material 30 and the insulating material could be bonded to the second flexible outer layer 34. In some embodiments, the layers can be bonded using thermal bonding or a suitable adhesive as discussed above. In other embodiments, the layers can be integrally formed together by coextrusion, pouring, laminating, spraying, or any process where the materials can be formed together when at least one can be in a molten state. In an embodiment, the layers can be formed such that the at least one layer of insulating material 30 can be sealed between the first flexible outer layer 32 and the second flexible outer layer 34 by a water-tight seal.

In some embodiments, each layer of insulating material 30 may, independently be made of closed cell foam, open cell foam, or other similar material. It can be made of any suitable material, including foamed polymers, such as polyethylene, polypropylene, polybutadiene, neoprene, nitrile rubber, polyurethane, polyamide, polyimide, silicone, butyl rubber, natural or synthetic rubber (including vulcanized rubber), EPDM, Polyvinyl Chloride Nitrile Butadiene Rubber, minicell foam, blends and copolymers, including polyvinyl chloride blended with any of the foregoing, and any other foamable material, preferably a foamed elastomer. In an embodiment, the insulation layer has a thickness of about 0.1, 0.2, 0.25, 0.3, 0.4, 0.5, 0.6, 0.7, 0.75, 0.8, 0.9, 1.0, 1.1, 1.2, 1.25, 1.3, 1.4, 1.5 inches, or a range of any of the proceeding thicknesses. In some embodiments, the thickness of the layer of insulating material 30 can be between 0.1 and 1 inch. In an embodiment, the thickness of the layer of insulating material 30 can be between about 0.25 and about 0.5 inches thick.

Also disclosed is a method of covering a pool 10. In some embodiments, a rotational force can be provided to a roller 14 that can be connected to at least one edge of an insulating cover 12 and said rotational force causes the insulating cover 12 to unwind from the roller 14.

In an embodiment, at least one leading edge of the insulating cover 12 can be guided across the pool from an open position, wherein the insulating does not substantially cover the pool 10, to a closed position, wherein the insulating cover substantially covers the pool 10. In some embodiments, the leading edge of the insulating cover 12 can be guided across the pool 10 by passing at least one bead 28 connected to the edge of the insulating cover 12 through the inside hollow portion 24 of the guide 18. The guide 18 may be made of a strong rigid material such as aluminum, steel, iron, or other metal. In some embodiments, the guide 18 can be made of aluminum. In an embodiment, the guide 18 can be made from extruded aluminum.

In some embodiments, the guide 18 can be mounted using one or more mounting brackets. FIG. 5 depicts several views of mounting brackets 44 and 46. In some embodiments, mounting brackets 44 and 46 can be used to mount the guide 18 to the pool or any other structure. In an embodiment, mounting brackets 44 and 46 comprise two sides that form right angles. On one side of each mounting bracket 44 and 46, the brackets can contain mounting holes 48 and 50, respectively. On the other side of each mounting bracket 44 and 46, the brackets can contain mounting slots 52 and 54, respectively. Mounting holes 48 and 50 can be used to secure each bracket to the pool 10, another structure, or the guide 18. Mounting slots 52 and 54 can allow mounting brackets 44 and 46 to be attached to each other. In some embodiments, mounting bracket 44 can be secured to the side of the pool 10 using mounting holes 48 and mounting bracket 46 can be secured to the guide 18 using mounting holes 50. In some embodiments, mounting bracket 44 can then be attached to mounting bracket 46 using mounting slots 52 and 54. In that embodiment, the guide 18 can be effectively mounted to the pool 10 using the mounting brackets 44 and 46 in combination.

### EXAMPLES

### Temperature Retention Test

The rate of cooling was determined for six different insulating materials and a control. Water was heated to greater than 100° F. and placed in seven plastic containers. Five lids of different insulating materials were placed on five of the containers and the control container was left open to the atmosphere. The temperature for each container was measured at the beginning of the test and after seven hours. The rate of cooling for each insulating material was calculated using Newton's law of cooling:

$$k = - \frac{ln ( \frac{( {T}_{end} - {T}_{ambient} )}{( {T}_{start} - {T}_{ambient} )} )}{7 hours}$$

TABLE 1
Rate of Cooling

| | Example | | | | | |
|---|---|---|---|---|---|---|
| | 1 | 2 | 3 | 4 | 5 | 6 |
| Insulating | None | Fabric | Fabric + | Fabric + | Fabric + | 3″ Foam |
| Material | | | Foil | Foil + | Foil + | |
| | | | | Fabric | ¼″ Foam + | |
| | | | | | Fabric | |
| K | 0.173 | 0.046 | 0.057 | 0.046 | 0.034 | 0.038 |

As shown in Table 1, Example 5, which used two layers of fabric, aluminum foil, and ¼″ closed-cell foam had k=0.034, the lowest rate of cooling. Example 6, which used the industry-standard 3″ foam had k=0.038, the second lowest rate of cooling. Examples 2 and 4 had the next lowest rate of cooling, followed by Example 3. Finally, Example 1, the control, had a much greater rate of cooling than any other example. The Examples illustrate that even a thin layer of closed cell foam is surprisingly effective in retaining heat, and that the beneficial effect is not primarily attributable to foil alone, but to the thin foam. Thus, even a modest amount of insulating foam produces a major benefit in reducing heat loss from a body of heated water.

While the above detailed description has shown, described, and pointed out novel features as applied to various embodiments, it will be understood that various omissions, substitutions, and changes in the form and details of the devices and processes illustrated may be made by those skilled in the art without departing from the spirit of the invention. As will be recognized, the present invention may be embodied within a form that does not provide all of the features and benefits set forth herein, as some features may be used or practiced separately from others.

What is claimed is:

1. A system for covering a manmade pool, comprising:
an insulating cover, wherein said insulating cover comprises at least one insulation layer and at least one flexible outer layer that substantially covers the at least one insulation layer;
a web of fibrous reinforcing material in the insulating cover;
a roller positioned along one edge of the pool, wherein the roller is attached to at least one edge of the insulating cover, wherein the insulating cover is sufficiently flexible and durable that it can be repetitively wound upon and unwound from the roller;
an actuator for rotating the roller;
a guide capable of guiding at least one leading edge of the insulating cover across the pool, such that the insulating cover can be moved from an open position, with the insulating cover wound around the roll, to a closed position, with the insulating cover secured over the pool; wherein the reinforcing material adds sufficient strength to the cover that when in the closed position over the pool, the cover can support the weight of at least one adult human.

2. The system of claim 1, wherein the at least one insulation layer comprises at least one type of flame bondable foam and wherein the at least one insulation layer is bonded to the at least one flexible outer layer using flame bonding.

3. The system of claim 1, wherein the at least one flexible outer layer comprises a first flexible outer layer and a second flexible outer layer, and wherein the at least one insulation layer is positioned between the first flexible outer layer and the second flexible outer layer.

4. The system of claim 3, wherein the first flexible outer layer and the at least one insulation layer are glued together, and wherein the second flexible outer layer and the at least one insulation layer are glued together.

5. The system of claim 1, wherein the at least one insulation layer comprises a closed cell foam having a thickness of about ⅛ inch to ½ inch.

6. The system of claim 1, wherein the at least one insulation layer comprises a closed cell foam having a weight of about 2 lbs/ft³.

7. The system of any of claim 1, wherein the fibrous reinforcing material is a mesh that comprises a polyester or dacron mesh.

8. The system of any of claim 1, wherein the at least one flexible outer layer comprises poured vinyl reinforced with a mesh material.

9. The system of claim 1, wherein the actuator comprises a hand crank.

10. The system of claim 1, wherein the actuator is a motor.

11. The system of claim 1, wherein the guide is positioned along an edge of the pool that is perpendicular to roller, and wherein the insulating covers comprises at least one bead, wherein the at least one bead is configured to fit inside the at least one guide.

12. The system of claim 1, wherein the insulating cover comprises at least one layer of metalized material.

13. An insulating cover comprising:
at least one insulation layer, wherein the at least one insulation layer comprises closed cell foam having a thickness between about 0.1 and 1 inch;
a reinforcing mesh layer; and
at least one flexible outer layer that substantially covers the at least one insulation layer, wherein:
the mesh layer is embedded in the at least one flexible outer layer or the closed cell foam;
the foam is enclosed by the at least one flexible outer layer;
the insulating cover comprises a sheet of material having edges and is sufficiently flexible and durable that it can be repetitively wound upon and unwound from a roller; and
the insulated cover has sufficient strength that when supported by its edges and covering a spa, it can support an adult human.

14. The insulating cover of claim 13, wherein the closed cell foam is a flame bondable foam and wherein the closed cell foam is bonded to the at least one flexible outer layer using flame bonding.

15. The insulating cover of claim 13, wherein the at least one flexible outer layer comprises a first flexible outer layer and a second flexible outer layer, and wherein the at least one insulation layer is positioned between the first flexible outer layer and the second flexible outer layer.

16. The insulating cover of claim 13, wherein the first flexible outer layer and the at least one insulation layer are glued together, and wherein the second flexible outer layer and the at least one insulation layer are glued together.

17. The insulating cover of claim 13, wherein the at least one insulation layer comprises a closed cell foam having a weight of about 2 lbs/ft³.

18. The insulating cover of claim 13, wherein the at least one insulation layer comprises closed cell foam having a thickness of between about 0.25 and about 0.5 inches.

19. The insulating cover of claim 13, wherein the mesh material comprises a polyester or dacron mesh.

20. The insulating cover of claim 13, wherein the insulating cover comprises at least one layer of mylar.

21. A method of manufacturing an insulating cover comprising:
pouring or laminating vinyl onto a mesh reinforcement material to form at least one flexible outer layer;
substantially covering at least one layer of insulating material with the at least one flexible outer layer; and
bonding the at least one insulation layer to the at least one flexible outer layer.

22. The method of claim 21, wherein the at least one insulation layer comprises at least one type of flame bondable foam and wherein bonding the at least one insulation layer to the at least one flexible outer layer comprises flame bonding the at least one foam to the flexible outer layer.

23. The method of claim 21, wherein the at least one flexible outer layer comprises a first flexible outer layer and a second flexible outer layer, and wherein bonding the at least one insulating layer to the at least one flexible outer layer comprises bonding the at least one insulation layer between the first flexible outer layer and the second flexible outer layer.

24. The method of claim 23, wherein bonding the at least one insulation layer between the first flexible outer layer and the second flexible outer layer comprises gluing the first flexible outer layer to the at least one insulation layer and gluing the second flexible outer layer to the at least one insulation layer.

25. The method of claim 21, wherein bonding the at least one insulation layer between the first flexible outer layer and the second flexible outer layer comprises integrally forming the at least one insulation layer, first flexible outer layer, and second flexible outer layer.

26. The insulating cover of claim 13, wherein the at least one insulation layer comprises a closed cell foam having a weight of about 2 lbs/ft³.

27. The method of claim 21, wherein the at least one insulation layer comprises 0.125 inch to 0.5 inch foam.

28. The method of claim 21, wherein the mesh reinforcement material comprises polyester or dacron mesh.
